(19) United States
(12) Patent Application Publication
(10) Pub. No.: US 2015/0198540 A1
(43) Pub. Date: Jul. 16, 2015

(54) DRY REAGENT BASED WATER ANALYZER

(71) Applicant: Ecolab USA Inc., Naperville, IL (US)

(72) Inventors: Hua Zheng, Naperville, IL (US); Ning Jin, Shanghai (CN); Fei Xia, Shanghai (CN); Ling Liang, Shanghai (CN); Chunbo Yu, Shanghai (CN); Lin Jiang, Shanghai (CN); Ling Feng Han, Shanghai (CN)

(73) Assignee: Ecolab USA Inc., Naperville, IL (US)

(21) Appl. No.: 14/152,637

(22) Filed: Jan. 10, 2014

(51) Int. Cl. G01N 21/94

(52) U.S. Cl. CPC G01N 21/94

(57) ABSTRACT

The invention provides devices, methods, and compositions for dry chemical reagents to measure calcium, magnesium (total hardness), and other analytes in water using colorimetric devices. The measurement may be a one-step procedure without the need of dilution and multi-step preparation, so that it can be easily employed by untrained personnel. The chemical reagents may include dyes, buffer reagents, masking reagents, competing ligands, and other chemicals such as fillers. The chemical reagents may be grinded together as a homogenous fine powder, equally dispensed into small containers for each test or dried as film or solid using the means of air, low heat or vacuum. The composition may be easily dissolved into water samples and stable for long term storage. The methods may be able to distinguish between similar materials such as magnesium and calcium with the same one reagent or from other interfering species in water samples

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

The invention relates to compositions, methods, and apparatuses for improving the detection, identification, and measurements of one or more analytes in a sample of water. Heating, cooling, and ventilation consume large amounts of water in industrial plants, commercial buildings and other facilities. Scaling can impede the flow of water in pipes and through the cooling tower, and coat surfaces which prevents the efficient transfer of heat. Concentrations of calcium, magnesium, or total hardness (calcium plus magnesium) in cooling water are important parameters that govern the scaling potential. They should be monitored regularly to prevent scaling, extend equipment life and reduce use of water, energy, water treatment chemicals.

There are many ways to measure calcium and magnesium in water, and atomic absorption is widely accepted as the reference method. However, atomic absorption requires expensive instrumentation and a skilled operator to perform assays. The colorimetric measurement is a convenient and inexpensive alternative. Over the years, many dyes were developed to show color changes upon interacting with calcium or magnesium, such as orthocresolphthalein (CPC), methylthymol blue, arsenazo III, chlorophosphonazo III, xylidyl blue, Eriochrome Black T, etc. In order to have the suitable condition for color developing, other reagents such as buffers, masking reagents are also required. Absorbance, transmittance or reflectance at a certain wavelength or a wavelength range can be acquired by a spectrophotometer. A calibration curve with known calcium or magnesium concentration is often obtained in the first place, and concentration of calcium or magnesium is then calculated from the calibration curve. On a crude level, color charts can be used to estimate the magnitude of calcium, magnesium or total hardness concentration.

Nowadays, it's possible to measure calcium, magnesium or total hardness in the field using battery-powered spectrophotometers. However, cooling water samples are difficult to measure directly using these handheld devices. Depending on the hardness of makeup water and cycles of concentration, calcium or magnesium concentration in cooling water can reach as high as 1200 ppm (as CaCO3) for calcium and 800 ppm for magnesium (as CaCO3). To measure such high concentrations of calcium and magnesium, a dilution of the cooling water sample with distilled or deionized water is often needed. However, dilution is somewhat inconvenient to practice in the field and the advantage of handheld devices is diminished with the additional requirement of quantitatively adding distilled water along with other chemicals. High hardness water also poses other challenges. For example, selective masking of calcium and magnesium against each other is often difficult for high hardness water. In addition, precipitate may form between calcium/magnesium and the dye, buffer components and other chemical reagents, giving high background signals and inaccurate readings for high hardness water.

Another problematic aspect of portable colorimetric measurement is that accuracy is often compromised for the sake of convenience. Many cooling water components or parameters may interfere with calcium and magnesium measurement. For example, cooling water may contain polyphosphate and dispersants which bind calcium and magnesium, alkalinity which alters pH, chlorine which may bleach the dye, and heavy metals such as iron, zinc and copper which often bind the dye stronger than calcium/magnesium. With only a pre-loaded calibration curve in handheld spectrophotometers, it is challenging to circumvent all these interferences. Measurement accuracy is further compromised if the chemical reagents are immobilized onto bibulous material, such as paper test strips. The extra steps of immersing test strips with chemical reagents solution and drying often bring additional uncertainties in terms of ratio of chemical reagents to sample volume and extra errors. Therefore, measurement by test strips or sticks is typically unsatisfactory for cooling water applications.

There are many established colorimetric methods to measure calcium/magnesium/total hardness in the prior art. The dye, orthocresolphthalein complexone (OCPC) was first described in 1955 (Analyst 80, 713, 1955). OCPC is distinctly advantageous over other calcium/magnesium sensitive dyes due to its low background and intense purple color. Thereafter, OCPC based colorimetric measurement has been continually evolved. For example, U.S. Pat. No. 3,938,954 described an alkaline buffer system containing 2-(Ethylamino)ethanol. U.S. Pat. No. 4,871,678 introduced a new sulphonic acid amine based zwitterionic buffer system. U.S. Pat. No. 5,376,552 described a series of phenolic ligand as masking reagent. U.S. Pat. No. 5,968,833 and Ser. No. 69/994,973 B2 taught methods of making calcium, and total hardness dry test strips based on OCPC. However, the disclosed methods are generally unable to directly give accurate readings for cooling water samples.

Thus there is clear utility in novel methods, compositions, and apparatuses for the detection, identification, and measurements of one or more analytes in a sample of water. The art described in this section is not intended to constitute an admission that any patent, publication or other information referred to herein is “prior art” with respect to this invention, unless specifically designated as such. In addition, this section should not be construed to mean that a search has been made or that no other pertinent information as defined in 37 CFR §1.56(a) exists.

### BRIEF SUMMARY OF THE INVENTION

To satisfy the long-felt but unsolved needs identified above, at least one embodiment of the invention is directed towards a method of testing for the presence of an analyte in a liquid sample. The method comprises the steps of: i) pre-determining the spectrographic relationship between a given amount of dry reagent and varying concentrations of an analyte when combined in a given amount of liquid carrier, ii) adding a sample of the liquid carrier to a container bearing the given amount of dry reagent, and iii) spectrographically measuring the amount of analyte in the sample.

The analyte may be magnesium and or calcium. The liquid carrier may be water. The dry reagent may be one that will indicate a positive result for both calcium and magnesium, but the method further comprises the step of adding a masking compound to sufficiently inhibit spectrographic interactions between calcium and the dry reagent so a measurement of only magnesium can be obtained. The dry reagent may be one which will indicate a positive result for both calcium and magnesium, but the method further comprises the step of adding a masking compound to sufficiently inhibit spectrographic interactions between magnesium and the dry reagent so a measurement of only calcium can be obtained.

The type of spectrographic measurement used may be colorimetry. The amount of analyte in the sample relative to the amount of dry reagent may be beyond a threshold for maximum possible accurate measurement, but the method further comprises contacting the sample with a ligand composition that reduces the amount of magnesium and calcium free to interact in proportional amounts so that an accurate measurement of calcium and magnesium can be obtained. It may be that but for the ligand composition the measurement would result in an absorbance of 3 AU or greater.

The reagents may be within a sealing container which may be vacuum sealed and may be stored for a period of time beyond which a liquid form version of the reagent would no longer be effective and conducting the measurement after the period of time has elapsed is still accurate. The dry reagent may comprises a dye, a chelating agent, and buffering agents, wherein the chelating agent is selected from a group consisting of hydroxy carboxylic acid salt and amino carboxylic acid salts, citric acid, phosphonobutane tricarboxylic acid, EDTA, and nitrilotriacetic acid, and any combination thereof; and the buffering agents can adjust pH in a range of from about 8 to about 10. The dye may be ortho-cresolphthalein complexone, OCPC and any combination thereof. The container may be one of a series of linked containers, each container containing a dry reagent suitable for measuring the amount of a different analyte in a liquid. The dry reagent may be in the form of a powder.

Additional features and advantages are described herein, and will be apparent from, the following Detailed Description.

### BRIEF DESCRIPTION OF THE DRAWINGS

A detailed description of the invention is hereafter described with specific reference being made to the drawings in which:

FIG. 1 is an example of a multi-well array suitable for simultaneously analyzing multiple parameters in a water sample.

FIG. 2 is a graph illustrating how prior art methods cannot distinguish between chlorides and sulfates.

FIG. 3A is a UV-Vis spectra curve of the invention as described in Table 1.

FIG. 3B is a calibration curve of the invention as described in Table 1.

FIG. 4A is a UV-Vis spectra curve of the invention as described in Table 2.

FIG. 4B is a calibration curve of the invention as described in Table 2.

FIG. SA is a UV-Vis spectra curve of the invention as described in Table 3.

FIG. 5B is a calibration curve of the invention as described in Table 3.

For the purposes of this disclosure, like reference numerals in the figures shall refer to like features unless otherwise indicated. The drawings are only an exemplification of the principles of the invention and are not intended to limit the invention to the particular embodiments illustrated.

### DETAILED DESCRIPTION OF THE INVENTION

The following definitions are provided to determine how terms used in this application, and in particular how the claims, are to be construed. The organization of the definitions is for convenience only and is not intended to limit any of the definitions to any particular category.

“Absorbance” means a quantitative measure expressed as a logarithmic ratio between the radiation falling upon a material and the radiation transmitted through a material according to the equation:

$${A}_{λ} = - {log}_{10} ( \frac{{I}_{1}}{{I}_{0}} )$$

where A_{λ} is the absorbance at a certain wavelength of light (λ), I₁ is the intensity of the radiation (light) that has passed through the material (transmitted radiation), and I₀ is the intensity of the radiation before it passes through the material (incident radiation). The amount of light transmitted through a material diminishes exponentially as it travels through the material. Since the absorbance of a sample is measured as a logarithm, it is directly proportional to the thickness of the sample and to the concentration of the absorbing material in the sample. Although absorbance is properly unitless, it is often reported in “Absorbance Units” or AU. Any real measuring instrument has a limited range within which it can accurately measure absorbance. An instrument must be calibrated and checked against known standards if the readings are to be trusted. Many instruments will become non-linear (fail to follow the Beer-Lambert law) starting at approximately 2 AU (˜1% Transmission). The theoretical best accuracy for most commercially available instruments is in the range near 1 AU. The path length or concentration should then, when possible, be adjusted to achieve readings near this range. Further meanings of the term are described in the Compendium of Chemical Terminology. 2nd ed. (the “Gold Book”), Published by IUPAC, (1997).

“Chromogenic Agent” means one or more compositions of matter which interact with a sample of matter to induce a change in interaction between the sample of matter and electromagnetic radiation that can be detected with spectrometry. Chromogenic agents sometimes operate by forming transition changing complexes with the sample of matter.

“Complex” means one or more atoms, typically a metal (the core), bonded to a surrounding array of molecules (the ligands) via one or more bonding mechanisms including coordinate covalent bonds, dipolar bonds, and coordinated pi bonds. Metal complexes often have spectacular colors or have visible or invisible spectroscopic properties caused by electronic transitions in the complex often stimulated by the absorption of light or electromagnetic energy. These transitions often involve d-d transitions, where an electron in a d orbital on the core or ligand is readily excited by a photon to another d orbital of higher energy in an empty ligand or core-based orbital.

“Consisting Essentially of” means that the methods and compositions may include additional steps, components, ingredients or the like, but only if the additional steps, components and/or ingredients do not materially alter the basic and novel characteristics of the claimed methods and compositions.

“OCPC” means o-Cresolphthalein complex one (also sometimes referred to in the form “o-CPC”)

“Spectrometry” and “Spectroscopy” means the process of analyzing the interaction between a sample of matter and electromagnetic radiation to determine one or more chemical properties of the sample of matter. Forms of electromagnetic radiation used include but are not limited to one or more of microwave, terawave, infrared, near infrared, visible, ultraviolet, and x-ray radiation. The analysis includes measurements of one or more of the radiation's absorption, emission, fluorescence, colorometrics, color changes, reflection, scattering, impedance, refraction, and resonance by the sample of matter.

In the event that the above definitions or a description stated elsewhere in this application is inconsistent with a meaning (explicit or implicit) which is commonly used, in a dictionary, or stated in a source incorporated by reference into this application, the application and the claim terms in particular are understood to be construed according to the definition or description in this application, and not according to the common definition, dictionary definition, or the definition that was incorporated by reference. In light of the above, in the event that a term can only be understood if it is construed by a dictionary, if the term is defined by the Kirk-Othmer Encyclopedia of Chemical Technology, 5th Edition, (2005), (Published by Wiley, John & Sons, Inc.) this definition shall control how the term is to be defined in the claims.

At least one embodiment of the invention is directed towards a dry chemistry method in a solid form to measure one or more of: calcium, magnesium, and total hardness in a water sample in a convenient and accurate way using a spectrophotometric device. The solid may be powder. The spectrophotometric device may be a colorimetric measuring device. The measurement may be a one-step procedure without the need of pretreatments or multi-step preparation for color developing. Therefore, this method can be easily employed by someone without analytical chemistry expertise. The solid may comprise one or more chromogenic agents.

In at least one embodiment the water sample is cooling water. The measurement ranges may be wide enough to cover most cooling water requirements or other water samples with very high hardness with no dilution needed. The components of the test may be stable for long term storage and easily dissolved into water samples. The measurements may be accurate, reproducible and not susceptible to common cooling water interferences.

In at least one embodiment a first problem common to such measurements is addressed. Respective amounts of calcium and magnesium are often difficult to distinguish because as alkaline earth metals they both tend to respond similarly to many testing reagents. This can result in false positives for one when in fact the other is present. Because however each has unique properties that can result in different issues, it is important to be able to distinguish which one or how much of each is present.

In at least one embodiment a second problem common to such measurements is addressed. It is often beneficial to use the same one reagent to determine if one or both of calcium or magnesium is present in a system. Using the same reagent however can result in false positives. As a result a method is employed to determine the specific contribution that magnesium makes to the positive result and to determine the specific contribution that calcium makes.

In at least one embodiment a third problem common to such measurements is addressed. Often testing protocols are not effective for addressing “high concentrations” of analytes. Because many measurement protocols are optically based once a particular threshold is exceeded (such as up to and over 3 absorbance unit) the reading is “off the chart” i.e. it is so dark that no further measurement can be achieved. This requires adding cumbersome dilution steps to the process for more detail. As a result a method is employed to measure high concentrations (0 ppm −1200 ppm and higher) without additional dilutions.

In at least one embodiment a measurement method addresses the first problem, the second problem, the third problem, and any combination of two or more of these problems.

In at least one embodiment the solid form reagent employs an immobilization scheme allowing direct interaction between reagent and analyte in water without presence of a medium. The solid form reagents can be dry or wet and are immobilized in a well or a cuvette by means of air, low heat, vacuum, freeze drying or any other means. The reagents may be mixtures comprising one or more of: dye, buffer, masking reagent or any additives that are specific and amenable for measurement of analyte of interest by means of colorimetric reactions as well as for minimizing other interferences in water. There may be no medium such as paper or plastic pad or polymer film other than support of wall of the well or cuvette. The reagents are stable during immobilization process and readily re-dissolvable when in contact with water sample.

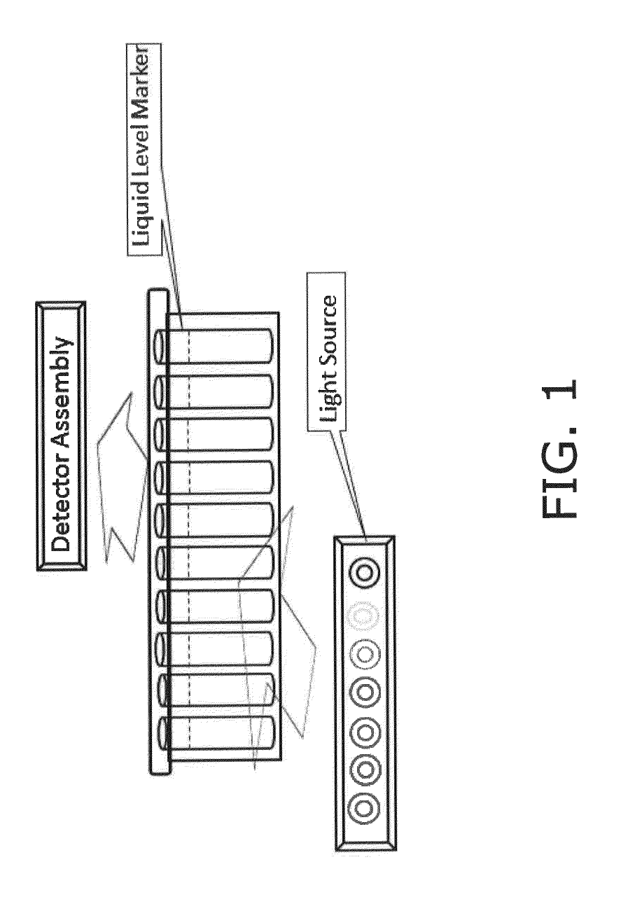

As illustrated in FIG. 1, in at least one embodiment the various solid form reagents are within a series of cuvettes facilitating simultaneous measurement of multiple analytes in one step. This allows for an array to simultaneously and in one step perform an analysis of multiple parameters in water.

In at least one embodiment the platform the analysis is performed on is small and compact. For example the capacity of each well where a reagent is positioned may be as small as 1 ml or less. Diameter of the wells may be narrow to maintain sufficient liquid level for light transmission but wide enough to ensure good mixing. The wells may be small enough to fit in a palm sized handheld detection device. The detection through side of the wells instead of up and down has the advantage of maintaining constant path length which is critical for minimizing variability of analyses. A further way of making the well set compact is maximizing number of analysis with minimal number of wells. This can be accomplished by pre-determined calibrations so that the wells are used for sample analysis only. In at least one embodiment one well is used for one analyte. As an example seven analytes would only need seven wells with an additional well for blank subtraction if needed.

In at least one embodiment one or more wells are pre-sealed with a peelable foil under nitrogen purge and vacuum to maintain reagent stability and shelf life. At analysis, the foil is peeled away; water sample is introduced and distributed to each well. Within minutes, color develops and measured by a handheld device. The detection is preferred in UV/Vis region equipped with multi wavelength detection, although other detection schemes such as fluorescence can also be added on if needed. Results will be generated from pre-determined calibration curves built in software of the measurement device. Various analysis algorithms are used including linear, quadratic regression and chemometrics wherever appropriate.

In at least one embodiment the method further includes the use of one or more reagents, apparatuses, and or methods described in any combination of one, some, and/or all of U.S. Pat. Nos. 3,938,954, 4,871,678, 5,376,552, 5,968,833, and 6,994,973, US Published Patent Applications: 2009/0286327 and 2011/0014087, and the scientific papers: Microscale Colorimetric Analysis Using a Desktop Scanner and Automated Digital Image Analysis, by D. Soldat et al., Journal of Chemical Education, Vol. 86, No. 5, pp. 617-620 (2009) and A Suite of Microplate Reader-Based Colorometric Methods to Quantify Ammonium, Nitrate, Orthophosphate and Silica Concentrations for Aquatic Nutrient Monitoring, by S. Ringuet et al., Journal of Environmental Monitoring, Vol. 13, pp. 370-376 (2011).

In at least one embodiment distinguishing between two parameters in a water sample that are both responsive to the same test can be accomplished by the use of a masking complex to shield one of the two parameters from the testing process and then measuring for the other. For example calcium and magnesium are similarly reactive to many of the same tests. As a result if a composition of matter is added that more competitively reacts with one of those two, this will leave the other of the two free to react with the testing reagent. In addition if the combined combination of the two parameters pushes the overall measurement off the chart, use of a ligand can reduce the amount of one or more free analytes to a level not off the chart and therefore an otherwise imprecise measurement can be rendered precise.

As an example in at least one embodiment in order to measure high hardness water directly, an additional ligand for calcium and magnesium is introduced into the formula. The competing ligand chelates both calcium and magnesium, reducing the availability of these ions to the dye and thus increasing the measuring range. The competing ligand should not bind calcium and magnesium too strongly, otherwise the dye might not be able to develop color, nor should it chelate calcium and magnesium too weakly, so that the measuring range cannot be tuned to the desired range.

In at least one embodiment the competing complexing ligand includes common ligands containing three or four carboxylic acid groups such as citric acid, phosphonobutane tricarboxylic acid, Ethylenediaminetetraacetic acid (EDTA), nitrilotriacetic acid, etc. The most preferred competing ligand is citric acid. The calibration curve may become slightly non-linear due to the competing ligands.

In at least one embodiment the competing ligand removes the majority of free calcium, magnesium and other heavy metals in solution. As a result, interferences from phosphate, dispersant and heavy metals are greatly reduced.

For high hardness water, there is a tendency to form precipitates between calcium, magnesium with components such as the dye and buffer. The competing ligand also serves the purpose of keeping everything in solution.

In at least one embodiment buffering reagents are also present to maintain the correct pH. Representative buffer systems include but are not limited to Tris, borate and/or glycine. Since sensitivity of OCPC is heavily dependent on pH, the buffer reagents may have sufficient strength to overwhelm alkalinity in the sample.

In at least one embodiment to measure calcium or magnesium separately, a masking reagent is used. The masking reagent preferentially binds calcium over magnesium or vice versa. Representative calcium masking reagent includes O,O′-bis(2-aminomethyl)ethylene glycol-N,N,N′,N′-tetraacetic acid (EGTA), trans-1,2-diaminocyclohexane-N,N,N′,N′-tetraacetic acid (CyDTA), and O,O′-bis(2-aminophenol)ethylene glycol-N,N,N′,N′-tetraacetic acid (BAPTA), and any combination thereof. Representative magnesium masking reagents include 8-hydroxyquinoline, 8-hydroxyquinoline-5-sulfonic acid, and any combination thereof. In at least one embodiment to measure total hardness of the water, color developing conditions such as pH, competing ligand concentration, and masking ligand concentration are finely adjusted so that the calcium and magnesium responses are similar.

The dye, buffer, competing ligands, masking reagents and other chemicals may be grinded together as a homogenous dry powder. The sensitivity and accuracy of the measurement depend on the concentrations of these chemicals and they are finely tuned so that the formula is best suited to measure water samples in the desired range.

OCPC is prone to decomposition in aqueous solution, especially at high pH. In powder form however its shelf life is extended significantly. For each test, OCPC may be used in very small quantities; its weight is typically less than 0.5% of total powder weight. If OCPC is not evenly distributed in the powders, the measurement accuracy might be greatly compromised.

In at least one embodiment the OCPC is evenly distributed through the reagent powder by dissolving OCPC along with a filler in an alcohol-water mixture and then evaporating to dryness, essentially diluting OCPC in the solid form. The resulting powder can then be grinded together with other components in the formula. The preferred fillers are organic acids such as citric acid, succinic acid, adipic acid, etc., and any combination thereof. The organic acids protect OCPC from contacting with other alkaline buffer reagents in the solid form, so that long term storage stability is further enhanced.

In at least one embodiment some or all of the reagents are grinded together as a homogenous fine powder. They can be equally dispensed into disposable bags, vials or cuvettes to allow easy measuring.

### Examples

The foregoing may be better understood by reference to the following examples, which are presented for purposes of illustration and are not intended to limit the scope of the invention. In particular the examples demonstrate representative examples of principles innate to the invention and these principles are not strictly limited to the specific condition recited in these examples. As a result it should be understood that the invention encompasses various changes and modifications to the examples described herein and such changes and modifications can be made without departing from the spirit and scope of the invention and without diminishing its intended advantages. It is therefore intended that such changes and modifications be covered by the appended claims.

A dry form reagent for detecting calcium was prepared using Arsenazo III (2,2′-(1,8-dihyxory-3,6-disulfonathlene-2,7-bisazo)bisbenzenearsonic acid). This reagent reacted with calcium immediately in acidic condition forming a blue purple complex. A buffer of triethanolamine or citric acid/phosphate maintains pH 5.6. The reagent is embedded in the well and air or low heat dried. When a water sample was introduced to the well, the reagent quickly dissolved and changed color. The dye amount was varied to measure low (2-10 ppm) or moderate concentrations of calcium (500 ppm as CaCO₃). The visible spectrum showed two peaks with the maximum absorbance at 650 nm and a weaker absorption at 540 nm. The maximum absorbance at 650 nm was used for measurement of low concentrations of calcium. Since color for the higher levels of calcium is very dark, the weaker absorption at 540 nm was used along with subtraction of the reagent blank. The color was stable and magnesium did not pose interference. A linear calibration curve for calcium between 2-10 ppm or 5-25 ppm CaCO₃ was formed with a correlation coefficient of 0.9822 (meaning it was 98.22% accurate), and another calibration curve for calcium up to 500 ppm as CaCO₃ displayed a correlation coefficient of 0.9970 with a quadratic regression.

A dry form reagent for detecting magnesium was prepared o-Cresophthalein complexone (o-CPC) which exhibited a stable brilliant magenta color when in contact with magnesium. A Tris buffer and EGTA (ethylene glycol-bis(2-amino-ethylether)-N, N,N′,N′-tetraacetic acid) was added to maintain the pH 7-8 and chelate calcium for reducing its interference. A calibration curve of magnesium from 10 to 1000 ppm as CaCO₃ at 570 nm displayed a coefficient of the linear regression 0.9992.

A dry form reagent for detecting phosphates was prepared based on phosphomolybdate chemistry. Ortho-phosphate reacts with molybdate in strong acidic medium to form a phosphomolybdate complex which in turn reacts with vanadium to form vanadomolybdophosphoric acid. Such an assay quantified phosphate concentration from 1-28 ppm although phosphate is usually very low in water. The color took 5-10 minutes to develop but was stable for hours. The resulting yellow color was faint but proportional to phosphate concentrations. The absorbance was detected at 355 nm. Silica did not interfere with the assay even though silica is a common interference for phosphate. The calibration curve was robust with an excellent correlation coefficient of 0.9936.

A dry form reagent for detecting silica was prepared using silicomolybdate chemistry. Silica and phosphate react with the molybdate ion in acidic conditions to form yellow silicomolybdic and phosphomolybdic acid complexes. Since phosphate in cooling water is very low, the interference is negligible. Silica was determined by measuring the yellow color which took about 10 minutes to develop. The colors were proportional to the silica concentrations and measured at 400 nm. An excellent linear regression curve with a correlation coefficient of 0.9999 for 5-200 ppm of silica standards was produced.

A dry form reagent for detecting acrylamide based polymers was prepared using a Nile Blue reagent. These polymers are commonly used for scale and corrosion control and can accumulate in process water. A representative polymer was tested for which is a terpolymer of acrylic acid, acrylamide and acryamidomethanesulfonic acid, sodium salt. The dosage of the product was measured using formulated Nile Blue reagent consisting of Nile Blue A and 2-phosphonobutane-1,2,4-tricarboxylic acid at 635 nm. The reaction was quick and able to measure 0.6 to 20 ppm of the polymer. A standard calibration curve with a quadratic fit resulted in a correlation coefficient of 0.9998.

A dry form reagent for detecting sulfate and chloride was prepared using a ferric sulfate complex. Field tests suitable for analysis of sulfate and chloride easily and quickly are scarce. The most common and established test for sulfate determination is turbidity test of BaSO₄ complex formed when BaCl₂ reacts with sulfate. Likewise, AgNO₃ is the most common reagent for chloride determination when AgCl is formed as precipitate. However, these turbidity based tests are difficult to be adapted for this integrated multi analyte approach on the dry reagent platform because they require precise control of the timing or temperature for reagent dissolution and turbidity development.

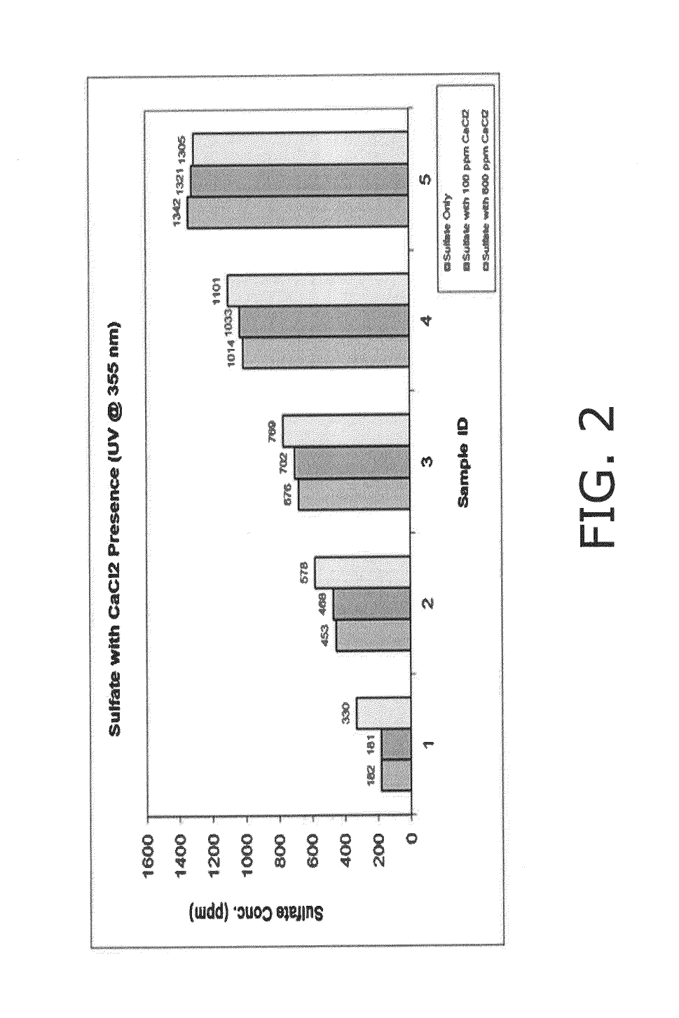

As a result, a method based on the formation of a ferric sulfate complex was used. The resulting complex was clear and colorless and can be measured by UV at 325 nm. The reaction was quick and one step, and measured sulfate up to 1000 ppm. However, chloride was the major interference for the test. An interference study was therefore performed. It showed that UV spectra of a mix standard of sulfate and chloride with ferric perchlorate reagent at around 340 nm are attributed to overlapping readings for sulfate and chloride. FIG. 2 illustrates that 100 ppm of chloride does not have significant interference on sulfate from 180 ppm to 1340 ppm. However, 600 ppm of chloride would almost double the sulfate result from 180 ppm to 330 ppm. But the interference effect decreases with increase of the sulfate concentrations at around 600-700 ppm and diminishes when the sulfate concentration is up to 1000 ppm or higher.

To turn the chloride interference to an advantage, chemometrics was employed to the overlapping UV/Vis spectra to facilitate simultaneous determination sulfate and chloride. A series of standard mixtures was made in random concentrations of sulfate and chloride in DI water and allowed to react with ferric perchlorate reagent. The reaction took place immediately and the reaction products were stable. The standards were scanned from 300-450 nm at 2 nm resolution. The UV spectra were then fit with partial least square algorithm using commercial chemometrics software. The resulting cross validation calibration curves of sulfate and chloride respectively showed both correlation coefficients scoring at least 0.99 or higher. Analysis of real samples showed good agreement between the reference method (ion chromatography) and this method.

Another series of experiments were conducted to demonstrate the efficacy of ligands and masking complexes in measuring parameters. The parameters were for the following common cooling water interferences were tested and errors were less than 10% for the examples shown here: calcium (1200 ppm as CaCO₃), magnesium (800 ppm as CaCO3), conductivity (8 ms/cm), turbidity (150 NTU), orthophosphate (20 ppm), polyphosphate (25 ppm), dispersant (30 ppm), free chlorine (3 ppm), alkalinity (700 ppm as CaCO3), silica (150 ppm), ammonium (5 ppm), zinc (3 ppm), aluminum (2 ppm), ferrous (2 ppm), ferric (2 ppm), copper (1 ppm) and nitrite (50 ppm).

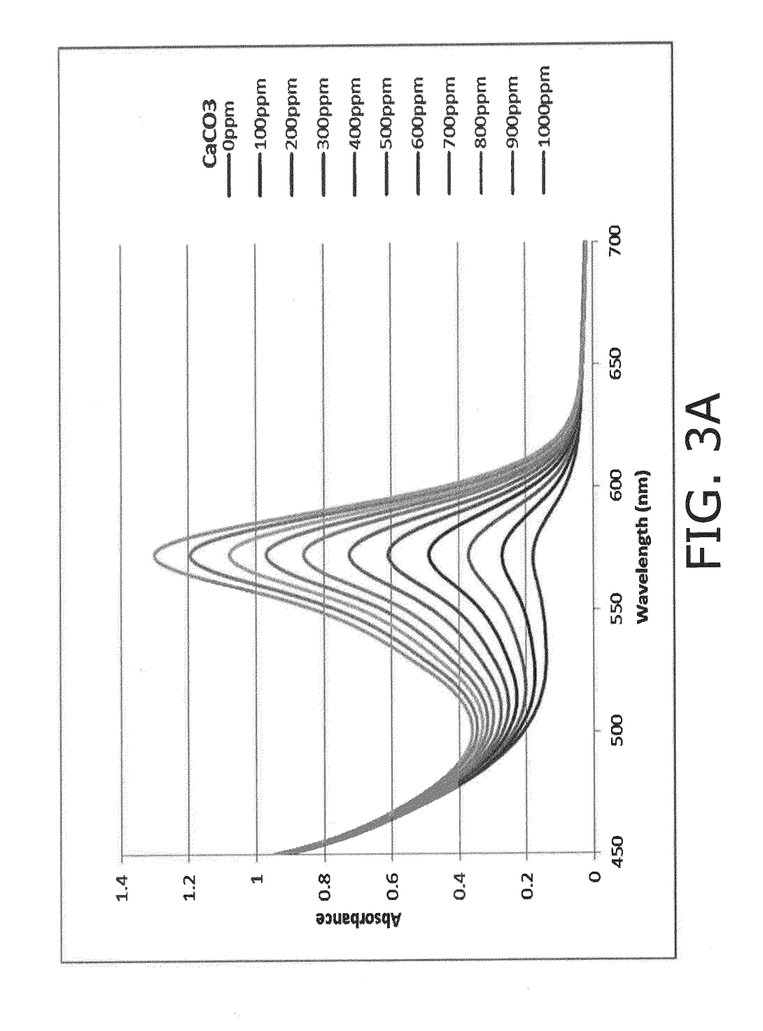

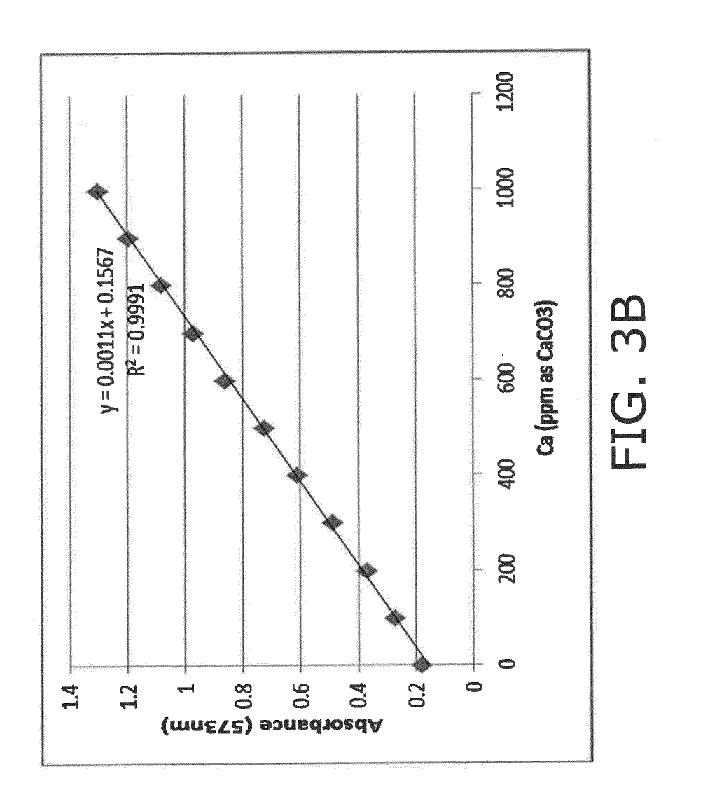

Table 1 illustrates an example of a reagent mixture for measuring calcium. Citric acid was used as a chelant that proportionally reduced the amount of free parameters in the water sample so that the otherwise off the chart sample could be measured using standard colorometric techniques. The 8-hydroxyquinoline-5-sulfuric acid was used to mask the magnesium. OCPC was used to measure the amount of calcium in the sample. FIGS. 3A and 3B illustrate the effectiveness of this measurement.

TABLE 1
A calcium measuring composition is prepared by the grinding follow
reagents together:

| Reagents | Weight (mg/mL sample) |
|---|---|
| OCPC | 0.153 |
| Citric acid | 3.057 |
| Trisodium Citrate | 29.410 |
| Sodium Tetraborate | 12.4 |
| Boric Acid | 1.660 |
| 8-hydroxyquinoline-5-sulfuric acid | 6.757 |

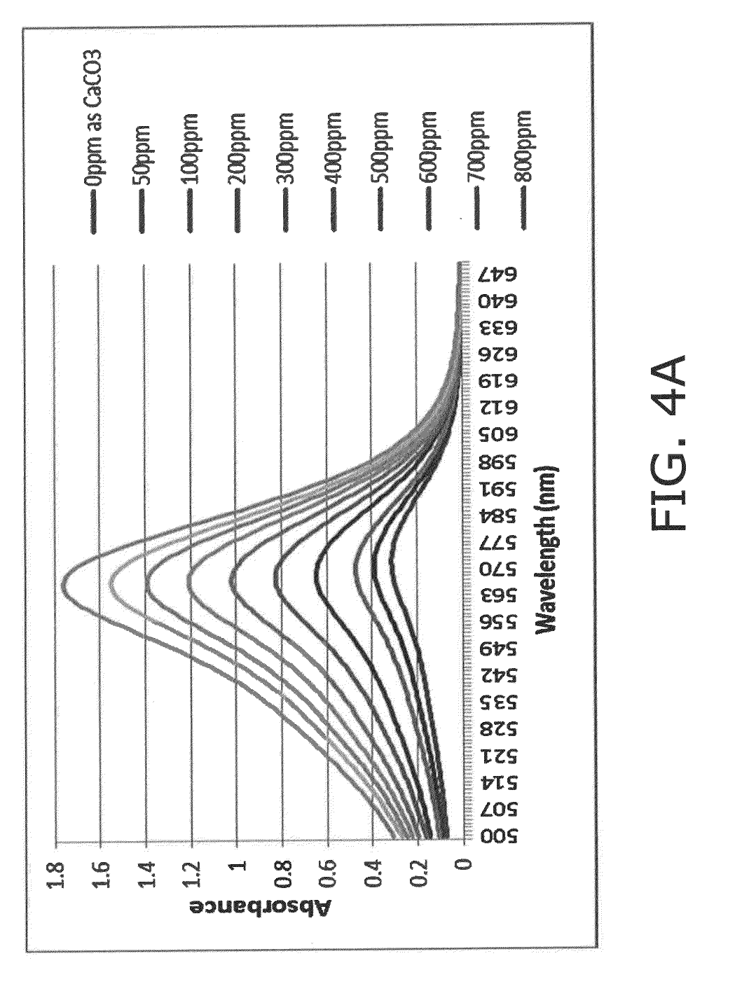

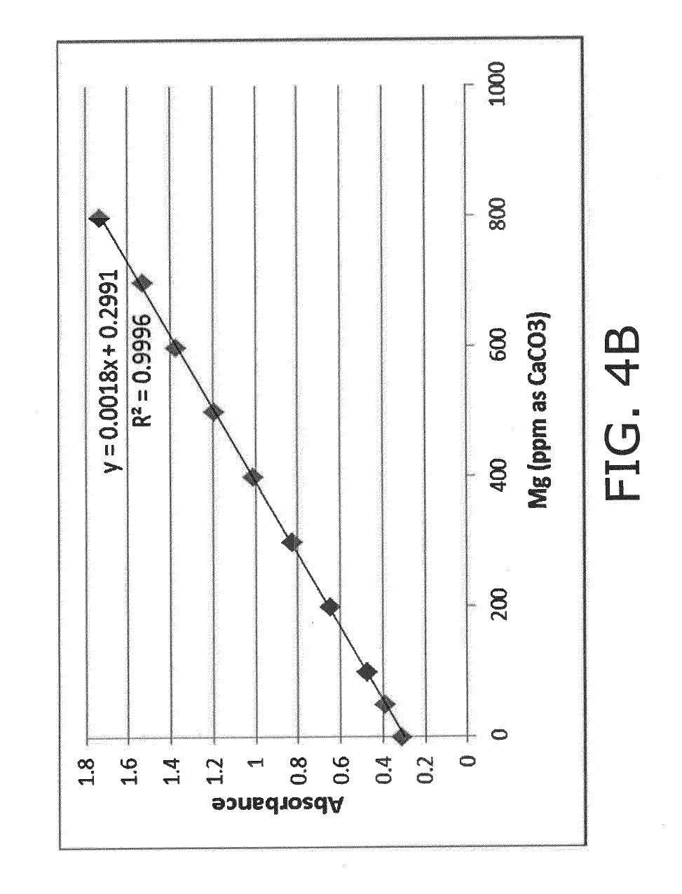

Table 2 illustrates an example of a reagent mixture for measuring magnesium. The EGTA masked the presence of the calcium. FIGS. 4A and 4B illustrate the effectiveness of this measurement.

TABLE 2
A magnesium measuring composition is prepared by grinding the follow
reagents together:

| Reagents | Weight (mg/mL sample) |
|---|---|
| OCPC | 0.204 |
| Citric acid | 4.08 |
| Trisodium Citrate | 16.9 |
| Sodium Tetraborate | 21.9 |
| Boric Acid | 0.73 |
| EGTA | 11.4 |

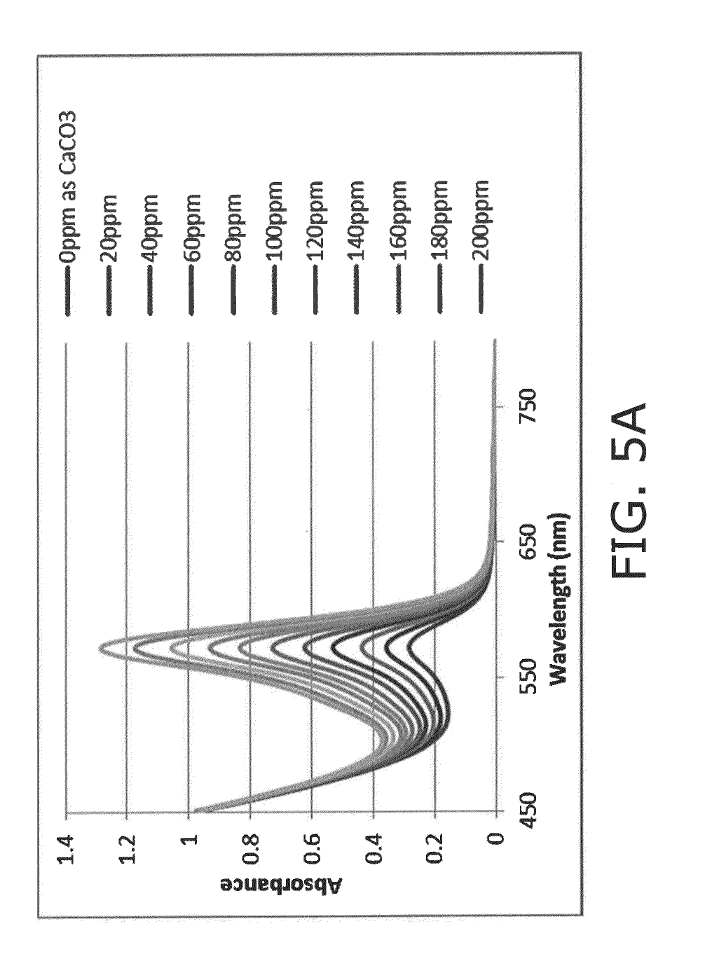

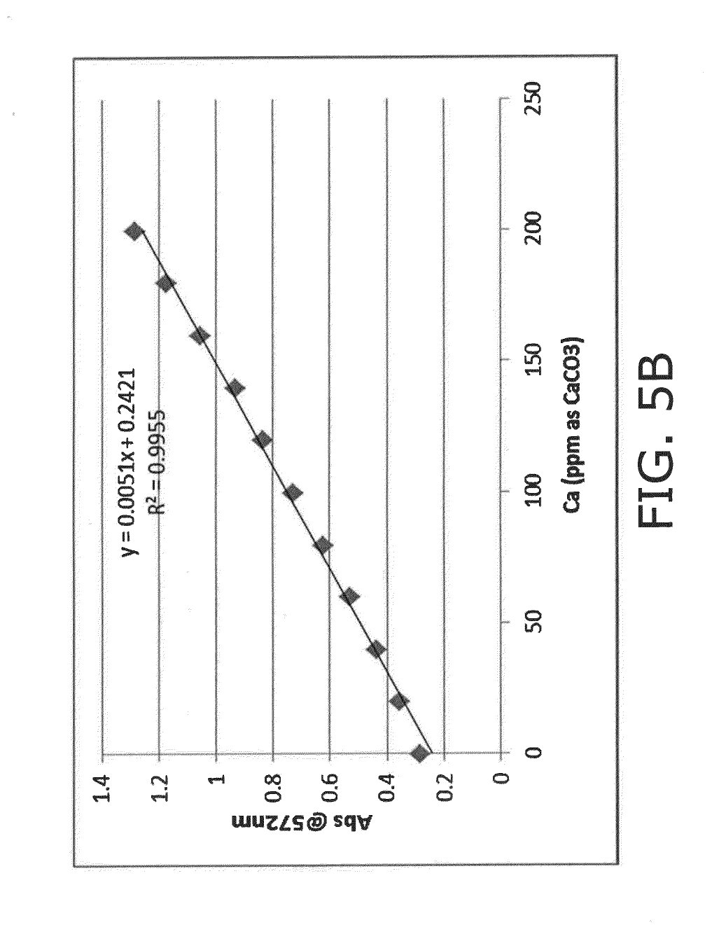

Table 3 illustrates an example if a low range calcium measuring composition. The composition was prepared by the grinding the listed reagents together. FIGS. 5A and 5B illustrate the effectiveness of this measurement.

TABLE 3

| Reagents | Weight (mg/mL sample) |
|---|---|
| OCPC | 0.102 |
| Citric acid | 2.04 |
| Trisodium Citrate | 13.2 |
| Sodium metaherate hydrate | 13.7 |
| Boric Acid | 2.83 |
| 8-hydroxyquinoline-5-sulfuric acid | 11.3 |

While this invention may be embodied in many different forms, there are described in detail herein specific preferred embodiments of the invention. The present disclosure is an exemplification of the principles of the invention and is not intended to limit the invention to the particular embodiments illustrated. All patents, patent applications, scientific papers, and any other referenced materials mentioned herein are incorporated by reference in their entirety. Furthermore, the invention encompasses any possible combination of some or all of the various embodiments mentioned herein, described herein and/or incorporated herein. In addition the invention encompasses any possible combination that also specifically excludes any one or some of the various embodiments mentioned herein, described herein and/or incorporated herein.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

All ranges and parameters disclosed herein are understood to encompass any and all subranges subsumed therein, and every number between the endpoints. For example, a stated range of “1 to 10” should be considered to include any and all subranges between (and inclusive of) the minimum value of 1 and the maximum value of 10; that is, all subranges beginning with a minimum value of 1 or more, (e.g. 1 to 6.1), and ending with a maximum value of 10 or less, (e.g. 2.3 to 9.4, 3 to 8, 4 to 7), and finally to each number 1, 2, 3, 4, 5, 6, 7, 8, 9, and 10 contained within the range. All percentages, ratios and proportions herein are by weight unless otherwise specified.

This completes the description of the preferred and alternate embodiments of the invention. Those skilled in the art may recognize other equivalents to the specific embodiment described herein which equivalents are intended to be encompassed by the claims attached hereto.

1. A method of testing for the presence of an analyte in a liquid sample comprising the steps of:
pre-determining the spectrographic relationship between a given amount of dry reagent and varying concentrations of an analyte when combined in a given amount of liquid carrier,
adding a sample of the liquid carrier to a container bearing the given amount of dry reagent, and
spectrometrically measuring the amount of analyte in the sample.

2. The method of claim 1 in which the analyte is magnesium and or calcium.

3. The method of claim 1 in which the liquid carrier is water.

4. The method of claim 2 in which the dry reagent will indicate a positive result for both calcium and magnesium, the method further comprising the step of adding a masking compound to sufficiently inhibit interactions between calcium and the dry reagent so a measurement of only magnesium can be obtained.

5. The method of claim 2 in which the dry reagent will indicate a positive result for both calcium and magnesium, the method further comprising the step of adding a masking compound to sufficiently inhibit interactions between magnesium and the dry reagent so a measurement of only calcium can be obtained.

6. The method of claim 2 in which the type of spectrometric measurement used is colorimetry.

7. The method of claim 2 in which the amount of analyte in the sample relative to the amount of dry reagent is beyond a threshold for maximum possible accurate measurement, the method further comprising contacting the sample with a ligand composition that reduces the amount of magnesium and calcium free to interact in proportional amounts so that an accurate measurement of calcium and magnesium can be obtained.

8. The method of claim 1 further comprising the step of vacuum sealing the container and storing it for a period of time beyond which a liquid form version of the reagent would no longer be effective and conducting the measurement after the period of time has elapsed.

9. The method of claim 1 in which the dry reagent comprises a dye, a chelating agent, and buffering agents, wherein the chelating agent is selected from a group consisting of hydroxy carboxylic acid salt and amino carboxylic acid salts, citric acid, phosphonobutane tricarboxylic acid, EDTA, and nitrilotriacetic acid, and any combination thereof; and the buffering agents can adjust pH in a range of from about 8 to about 10.

10. The composition according to the claim 9 wherein the dye is orthocresolphthalein complex one, OCPC and any combination thereof.

11. The method of claim 1 in which the container is one of a series of linked containers, each container containing a dry reagent suitable for measuring the amount of a different analyte in a liquid.

12. The method of claim 1 in which the dry reagent is in the form of a powder.

13. The method of claim 7 in which but for the ligand composition the measurement would result in an absorbance of 3 AU or greater.
